(19) United States
(12) Patent Application Publication
(10) Pub. No.: US 2026/0367268 A1
(43) Pub. Date: Nov. 19, 2026

(54) SYSTEMS AND METHODS FOR PREDICTING RESERVOIR PROPERTIES OF SUBSURFACE REGIONS USING FULL WAVEFORM INVERSION DEFINED REFLECTIVITY

(71) Applicant: BP Corporation North America Inc., Houston, TX (US)

(72) Inventor: Atish Roy, Katy, TX (US)

(73) Assignee: BP Corporation North America Inc., Houston, TX (US)

(21) Appl. No.: 19/653,262

(22) Filed: Jun. 30, 2026

Related U.S. Application Data
(60) Provisional application No. 63/791,796, filed on Apr. 21, 2025.

(51) Int. Cl. G01V 1/30; G01V 1/16; G01V 1/28

(52) U.S. Cl. CPC G01V 1/306; G01V 1/164; G01V 1/282

(57) ABSTRACT

A computer-implemented method for predicting reservoir properties of subsurface regions using full waveform inversion derived reflectivity (FDR) includes receiving FDR seismic data obtained from a subsurface region, receiving an augmented dataset that is different from the FDR seismic data and associated with the subsurface region, and integrating by a trained predictive model the FDR seismic data with the augmented dataset to predict one or more reservoir properties of the subsurface region.

### CROSS-REFERENCE TO RELATED APPLICATIONS

This application claims benefit of U.S. provisional patent application No. 63/791,796 filed Apr. 21, 2025, and entitled “Systems and Methods for Predicting Reservoir Properties of Subsurface Regions Using Full Waveform Inversion Defined Reflectivity”, which is incorporated herein by reference in its entirety for all purposes.

### BACKGROUND

Seismic surveying is a method of exploration geophysics in which seismology is used to estimate properties of earthen subsurface regions from reflection seismic waves. Seismic surveying generally includes imparting acoustic or sound waves into a natural environment so that the waves enter the Earth and travel through a subsurface region of interest. As the seismic waves encounter an interface between two materials of the subsurface region, some of the wave energy is reflected off of the interface where the reflection seismic wave energy may be observed or collected at the surface as seismic data associated with the subsurface region, while some of the wave energy refracts through the interface and penetrates deeper into the subsurface region. The reflection seismic wave energy observed at the surface as seismic data may be studied to ascertain information about the subsurface region. For example, the observed seismic data may be used to construct a velocity model of the subsurface region which models the velocity of the seismic waves passing through the subsurface region so as to translate subsurface reflection points of the seismic waves to their true depth within the formation. The seismic data observed by the receivers may also be used to create an image or profile of the corresponding subsurface region. Interpretation of these seismic images may provide a description of the geological features of the subsurface, such as faults, salts domes, anticlines, or other features indicative of the location and/or change in hydrocarbon deposits.

### SUMMARY

An embodiment of a computer-implemented method for predicting reservoir properties of subsurface regions using full waveform inversion derived reflectivity (FDR) comprises (a) receiving FDR seismic data obtained from a subsurface region (b) receiving an augmented dataset that is different from the FDR seismic data and associated with the subsurface region, and (c) integrating by a trained predictive model the FDR seismic data with the augmented dataset to predict one or more reservoir properties of the subsurface region. In some embodiments, the one or more reservoir properties are of a selected area of interest (AOI) contained in the subsurface region. In some embodiments, the FDR seismic data comprises a FDR image volume of the subsurface region. In certain embodiments, the augmented dataset comprises at least one of rock properties, processing data, and geologic data associated with the subsurface region. In certain embodiments, the augmented dataset comprises rock properties, processing data, and geologic data associated with the subsurface region. In some embodiments, the method comprises (d) extracting FDR amplitudes from the FDR seismic data at predefined intervals within the subsurface region, and wherein (c) comprises integrating by the trained predictive model the FDR amplitude data with the augmented dataset to predict the one or more reservoir properties of the subsurface region. In some embodiments, the FDR seismic data comprises FDR amplitudes at predefined intervals within the subsurface region. In certain embodiments, the one or more reservoir properties comprise a presence of hydrocarbons within the subsurface region. In certain embodiments, the FDR amplitudes comprise at least one of an average FDR amplitude, a minimum or maximum FDR amplitude, and a root means square (RMS) FDR amplitude. In some embodiments, the one or more reservoir properties comprises one or more fluid types present in the subsurface region.

An embodiment of a computer-implemented method for creating a trained predictive model for predicting reservoir properties of subsurface regions using FDR comprises (a) receiving FDR seismic data associated with a plurality of subsurface regions, (b) receiving a plurality of augmented datasets separate from the FDR seismic data and also associated with the plurality of subsurface regions, (c) creating a training dataset containing both the FDR seismic data and the augmented datasets wherein the FDR seismic data for each of the plurality of subsurface regions is correlated with a corresponding augmented dataset of the plurality of augmented datasets that is associated with the same subsurface region as the FDR seismic data, and (d) training a predictive model using the training dataset to create a trained predictive model for predicting reservoir properties of new subsurface regions besides the plurality of subsurface regions. In some embodiments, the FDR seismic data comprises FDR amplitudes at predefined intervals within a subsurface region of the plurality of subsurface regions associated with the FDR seismic data. In certain embodiments, the one or more reservoir properties comprise the presence of hydrocarbons within the subsurface region. In certain embodiments, the one or more reservoir properties comprises one or more fluid types present in the subsurface region. In some embodiments, (d) comprises training the predictive model to create the trained predictive model for predicting an ensemble of reservoir properties of the new subsurface regions.

An embodiment of a system comprises a one or more processors, and a storage device coupled to the one or more processors, the storage device configured to store instructions that, when executed by the one or more processors, configure the one or more processors to (a) receive FDR seismic data obtained from a subsurface region, (b) receive an augmented dataset that is different from the FDR seismic data and associated with the subsurface region, and (c) integrate by a trained predictive model the FDR seismic data with the augmented dataset to predict one or more reservoir properties of the subsurface region. In some embodiments, the FDR seismic data comprises FDR amplitudes at predefined intervals within the subsurface region. In certain embodiments, the one or more reservoir properties comprises the presence of hydrocarbons in the subsurface region. In certain embodiments, the one or more reservoir properties comprises one or more fluid types present in the subsurface region. In some embodiments, the FDR seismic data comprises a FDR image volume of the subsurface region.

### BRIEF DESCRIPTION OF THE DRAWINGS

For a detailed description of various exemplary embodiments, reference will now be made to the accompanying drawings in which:

FIG. 1 is a flow chart of various processes that may be performed based on analysis of seismic data acquired via a seismic survey system in accordance with principles disclosed herein;

FIG. 2 is a schematic diagram of an embodiment of a system for performing a marine seismic survey in accordance with principles disclosed herein;

FIG. 3 is a schematic diagram of an embodiment of a system for performing a land-based seismic survey in accordance with principles disclosed herein;

FIG. 4 is a block diagram of an embodiment of a computer system that may perform operations described herein based on data acquired via the marine survey system of FIG. 2 and/or the land survey systems of FIG. 3 in accordance with principles disclosed herein;

FIG. 5 is a flowchart of an exemplary method for providing a final predictive method configured to predict reservoir properties of a selected AOI within a subsurface region by integrating FDR seismic data with augmented data in accordance with principles disclosed herein;

FIG. 6 is a graphical representation of exemplary FDR seismic data in accordance with principles disclosed herein;

FIG. 7 is a flowchart of an exemplary method for conditioning integrated data in accordance with principles disclosed herein;

FIG. 8 is a flowchart of an exemplary method for producing a final predictive model from labeled training data in accordance with principles disclosed herein;

FIG. 9 is a flowchart of an exemplary ML ensemble technique in accordance with principles disclosed herein;

FIG. 10 is a flowchart of an exemplary method for providing an ensemble reservoir property prediction in response to receiving a user query in accordance with principles disclosed herein;

FIG. 11 is a flowchart of an exemplary method for obtaining integrated data in accordance with principles disclosed herein;

FIGS. 12A-12E are exemplary graphs depicting different rock properties of a subsurface region in accordance with principles disclosed herein;

FIGS. 13A and 13B are exemplary graphs depicting ensemble reservoir predictions in accordance with principles disclosed herein; and

FIGS. 14 and 15 are flowcharts of exemplary methods for predicting reservoir properties of subsurface regions using FDR in accordance with principles disclosed herein.

### DETAILED DESCRIPTION

The following discussion is directed to various exemplary embodiments. However, one skilled in the art will understand that the examples disclosed herein have broad application, and that the discussion of any embodiment is meant only to be exemplary of that embodiment, and not intended to suggest that the scope of the disclosure, including the claims, is limited to that embodiment.

Certain terms are used throughout the following description and claims to refer to particular features or components. As one skilled in the art will appreciate, different persons may refer to the same feature or component by different names. This document does not intend to distinguish between components or features that differ in name but not function. The drawing figures are not necessarily to scale. Certain features and components herein may be shown exaggerated in scale or in somewhat schematic form and some details of conventional elements may not be shown in the interest of clarity and conciseness.

In the following discussion and in the claims, the terms “including” and “comprising” are used in an open-ended fashion, and thus should be interpreted to mean “including, but not limited to . . . ” Also, the term “couple” or “couples” is intended to mean either an indirect or direct connection. Thus, if a first device couples to a second device, that connection may be through a direct connection of the two devices, or through an indirect connection that is established via other devices, components, nodes, and connections. In addition, as used herein, the terms “axial” and “axially” generally mean along or parallel to a particular axis (e.g., central axis of a body or a port), while the terms “radial” and “radially” generally mean perpendicular to a particular axis. For instance, an axial distance refers to a distance measured along or parallel to the axis, and a radial distance means a distance measured perpendicular to the axis. As used herein, the terms “approximately,” “about,” “substantially,” and the like mean within 10% (i.e., plus or minus 10%) of the recited value. Thus, for example, a recited angle of “about 80 degrees” refers to an angle ranging from 72 degrees to 88 degrees.

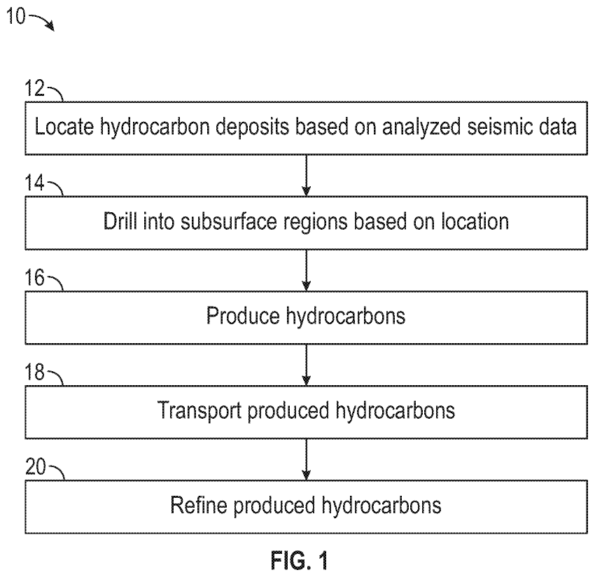

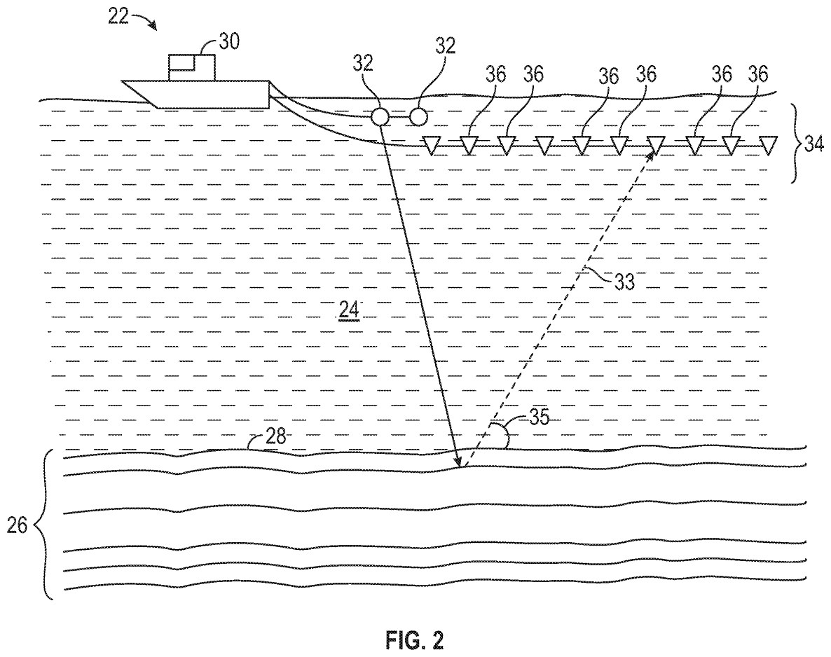

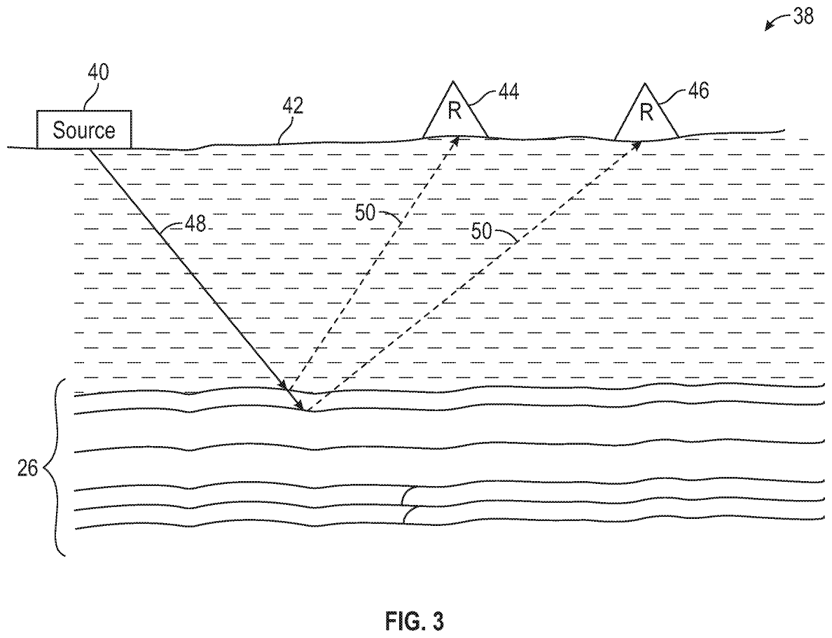

By way of introduction, seismic data may be acquired using a variety of seismic survey systems and techniques, two of which are discussed with respect to FIG. 2 and FIG. 3. Regardless of the seismic data gathering technique utilized, after the seismic data is acquired, a computing system may analyze the acquired seismic data and may use the results of the seismic data analysis (e.g., seismogram, map of geological formations, etc.) to perform various operations within the hydrocarbon exploration and production industries. For instance, FIG. 1 illustrates a flow chart of a method 10 that details various processes that may be undertaken based on the analysis of the acquired seismic data. Although method 10 is described in a particular order, it should be noted that the method 10 may be performed in any suitable order.

Referring now to FIG. 1, at block 12, locations and properties of hydrocarbon deposits within a subsurface region of the Earth associated with the respective seismic survey may be determined based on the analyzed seismic data. In one embodiment, the seismic data acquired may be analyzed to generate a map or profile that illustrates various geological formations within the subsurface region. Based on the identified locations and properties of the hydrocarbon deposits, at block 14, certain positions or parts of the subsurface region may be explored. That is, hydrocarbon exploration organizations may use the locations of hydrocarbon deposits to determine locations at the surface of the subsurface region to drill into the Earth. As such, the hydrocarbon exploration organizations may use the locations and properties of the hydrocarbon deposits and the associated overburdens to determine a path along which to drill into the Earth, how to drill into the Earth, and the like.

After exploration equipment has been placed within the subsurface region, at block 16, the hydrocarbons that are stored in the hydrocarbon deposits may be produced via natural flowing wells, artificial lift wells, and the like. At block 18, the produced hydrocarbons may be transported to refineries and the like via transport vehicles, pipelines, and the like. At block 20, the produced hydrocarbons may be processed according to various refining procedures to develop different products using the hydrocarbons.

It should be noted that the processes discussed with regard to method 10 may include other suitable processes that may be based on the locations and properties of hydrocarbon deposits as indicated in the seismic data acquired via one or more seismic survey. As such, the processes described above are not intended to depict an exhaustive list of processes that may be performed after determining the locations and properties of hydrocarbon deposits within the subsurface region.

With the foregoing in mind, FIG. 2 is a schematic diagram of a marine survey system 22 (e.g., for use in conjunction with block 12 of FIG. 1) that may be employed to acquire seismic data (e.g., waveforms) regarding a subsurface region of the Earth in a marine environment. Generally, a marine seismic survey using the marine survey system 22 may be conducted in an ocean 24 or other body of water over a subsurface region 26 of the Earth that lies beneath a seafloor 28.

The marine survey system 22 may include a vessel 30, one or more seismic sources 32, a (seismic) streamer 34, one or more (seismic) receivers 36, and/or other equipment that may assist in acquiring seismic images representative of geological formations within a subsurface region 26 of the Earth. Vessel 30 may tow the seismic source(s) 32 (e.g., an air gun array) that may produce energy, such as sound waves (e.g., seismic waveforms), that is directed at a seafloor 28. The vessel 30 may also tow the streamer 34 having a receiver 36 (e.g., hydrophones) that may acquire seismic waveforms that represent the energy output by the seismic source(s) 32 subsequent to being reflected off of various geological formations (e.g., salt domes, faults, folds, etc., represented schematically in FIG. 2 as subsurface reflectors 29) within the subsurface region 26. Particularly, the seismic energy may propagate through the subsurface region 26 as reflected seismic waves (indicated by arrow 33 in FIG. 2) that are reflect off of the subsurface region at a given angle 35. Additionally, although the description of the marine survey system 22 is described with one seismic source 32 (represented in FIG. 2 as an air gun array) and one receiver 36 (represented in FIG. 2 as a set of hydrophones), it should be noted that the marine survey system 22 may include multiple seismic sources 32 and multiple receivers 36. In the same manner, although the above descriptions of the marine survey system 22 is described with one seismic streamer 34, it should be noted that the marine survey system 22 may include multiple streamers similar to streamer 34. In addition, additional vessels 30 may include additional seismic source(s) 32, streamer(s) 34, and the like to perform the operations of the marine survey system 22.

FIG. 3 an exemplary land survey system 38 (e.g., for use in conjunction with block 12 of FIG. 1) that may be employed to obtain information regarding the subsurface region 26 of the Earth in a non-marine environment. The land survey system 38 may include a land-based seismic source 40 and land-based receiver 44. In some embodiments, the land survey system 38 may include multiple land-based seismic sources 40 and one or more land-based receivers 44 and 46. Indeed, for discussion purposes, the land survey system 38 includes a land-based seismic source 40 and two land-based receivers 44 and 46. The land-based seismic source 40 (e.g., seismic vibrator) that may be disposed on a surface 42 of the Earth above the subsurface region 26 of interest. The land-based seismic source 40 may produce energy (e.g., sound waves, seismic waveforms) that is directed at the subsurface region 26 of the Earth. Upon reaching various geological formations (e.g., salt domes, faults, folds) within the subsurface region 26 the energy output by the land-based seismic source 40 may be reflected off of the geological formations (e.g., subsurface reflectors 29) and acquired or observed by one or more land-based receivers (e.g., 44 and 46).

In certain embodiments, the land-based receivers 44 and 46 may be dispersed across the surface 42 of the Earth to form a grid-like pattern. As such, each land-based receiver 44 or 46 may receive a reflected seismic waveform in response to energy being directed at the subsurface region 26 via the seismic source 40. In some cases, one seismic waveform produced by the seismic source 40 may be reflected off of different geological formations and received by different receivers. For example, as shown in FIG. 3, the seismic source 40 may output energy that may be directed at the subsurface region 26 as seismic waveform 48. A first receiver 44 may receive the reflection of the seismic waveform 48 off one geological formation and a second receiver 46 may receive the reflection of the seismic waveform 48 off a different geological formation. As such, the first receiver 44 may receive a reflected seismic waveform 50 and the second receiver 46 may receive a reflected seismic waveform 52.

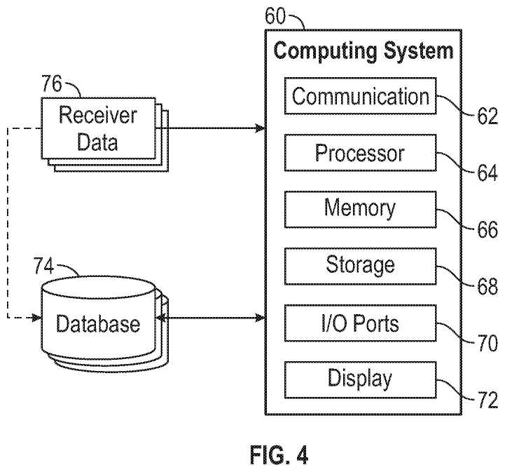

Regardless of how the seismic data is acquired, a computing system (e.g., for use in conjunction with block 12 of FIG. 1) may analyze the seismic waveforms acquired by the receivers 36, 44, 46 to determine seismic information regarding the geological structure, the location and property of hydrocarbon deposits, and the like within the subsurface region 26. FIG. 4 is a block diagram of an example of such a computing system 60 that may perform various data analysis operations to analyze the seismic data acquired by the receivers 36, 44, 46 to determine the structure and/or predict seismic properties of the geological formations within the subsurface region 26.

Referring now to FIG. 4, the computing system 60 may include a communication component 62, a processor 64, memory 66, storage 68, input/output (I/O) ports 70, and a display 72. In certain embodiments, the computing system 60 may omit one or more of the display 72, the communication component 62, and/or the input/output (I/O) ports 70. Further, the computing system 60 may comprise a graphics processing unit (GPU) for processing parallel tasks such as rendering graphics or performing complex computations efficiently. The communication component 62 may be a wireless or wired communication component that may facilitate communication between the receivers 36, 44, 46, one or more databases 74, other computing devices, and/or other communication capable devices. In one embodiment, the computing system 60 may receive receiver data 76 (e.g., seismic data, seismograms, etc.) via a network component, the database 74, or the like. The processor 64 of the computing system 60 may analyze or process the receiver data 76 to ascertain various features regarding geological formations within the subsurface region 26 of the Earth. The processor 64 may be any type of computer processor or microprocessor capable of executing computer-executable code.

The processor 64 may also include multiple processors that may perform the operations described below. The memory 66 and the storage 68 may be any suitable articles of manufacture that can serve as media to store processor-executable code, data, or the like. These articles of manufacture may represent computer-readable media (e.g., any suitable form of memory or storage) that may store the processor-executable code used by the processor 64 to perform the presently disclosed techniques. Generally, the processor 64 may execute software applications that include programs that process seismic data acquired via receivers of a seismic survey according to the embodiments described herein.

With one or more embodiments, processor 64 can instantiate or operate in conjunction with one or more seismic inversion techniques. With another embodiment, the computing system 60 can be implemented by using neural networks. The one or more neural networks can be software-implemented or hardware-implemented. One or more of the neural networks can be a convolutional neural network.

The memory 66 and the storage 68 may also be used to store the data, analysis of the data, the software applications, and the like. Memory 66 and the storage 68 may represent non-transitory computer-readable media (e.g., any suitable form of memory or storage) that may store the processor-executable code used by processor 64 to perform various techniques described herein. It should be noted that non-transitory merely indicates that the media is tangible and not a signal.

The I/O ports 70 may be interfaces that couple to other peripheral components such as input devices (e.g., keyboard, mouse), sensors, input/output (I/O) modules, and the like. I/O ports 70 may enable the computing system 60 to communicate with the other devices in the marine survey system 22, the land survey system 38, or the like via the I/O ports 70.

The display 72 may depict visualizations associated with software or executable code being processed by the processor 64. In one embodiment, display 72 may be a touch display capable of receiving inputs from a user of the computing system 60. The display 72 may also be used to view and analyze results of the analysis of the acquired seismic data to determine the geological formations within the subsurface region 26, the location and property of hydrocarbon deposits within the subsurface region 26, predictions of seismic properties associated with one or more wells in the subsurface region 26, and the like. The display 72 may be any suitable type of display, such as a liquid crystal display (LCD), plasma display, or an organic light emitting diode (OLED) display, for example. In addition to depicting the visualization described herein via the display 72, it should be noted that the computing system 60 may also depict the visualization via other tangible elements, such as paper (e.g., via printing) and the like.

With the foregoing in mind, the present techniques described herein may also be performed using a supercomputer that employs multiple computing systems 60, a cloud-computing system, or the like to distribute processes to be performed across multiple computing systems 60. In this case, each computing system 60 operating as part of a super computer may not include each component listed as part of the computing system 60. For example, each computing system 60 may not include the display 72 since multiple displays 72 may not be useful to for a supercomputer designed to continuously process seismic data.

After performing various types of seismic data processing, the computing system 60 may store the results of the analysis in one or more databases 74. The databases 74 may be communicatively coupled to a network that may transmit and receive data to and from the computing system 60 via the communication component 62. In addition, the databases 74 may store information regarding the subsurface region 26, such as previous seismograms, geological sample data, seismic images, and the like regarding the subsurface region 26.

Although the components described above have been discussed with regard to the computing system 60, it should be noted that similar components may make up the computing system 60. Moreover, the computing system 60 may also be part of the marine survey system 22 or the land survey system 38, and thus may monitor and control certain operations of the seismic sources 32 or 40, the receivers 36, 44, 46, and the like. Further, it should be noted that the listed components are provided as example components and the embodiments described herein are not to be limited to the components described with reference to FIG. 4.

In some embodiments, the computing system 60 may generate a two-dimensional representation or a three-dimensional representation of the subsurface region 26 based on the seismic data received via the receivers mentioned above. Additionally, seismic data associated with multiple source/receiver combinations may be combined to create a near continuous profile of the subsurface region 26 that can extend for some distance. In a two-dimensional (2-D) seismic survey, the receiver locations may be placed along a single line, whereas in a three-dimensional (3-D) survey the receiver locations may be distributed across the surface in a grid pattern. As such, a 2-D seismic survey may provide a cross-sectional picture (vertical slice) of the Earth layers as they exist directly beneath the recording locations. A 3-D seismic survey, on the other hand, may create a data “cube” or volume that may correspond to a 3-D picture of the subsurface region 26.

In addition, a 4-D (or time-lapse) seismic survey may include seismic data acquired during a 3-D survey at multiple times. Using the different seismic images acquired at different times, the computing system 60 may compare the two images to identify changes in the subsurface region 26. In any case, a seismic survey may be composed of a very large number of individual seismic recordings or traces. As such, the computing system 60 may be employed to analyze the acquired seismic data to obtain an image representative of the subsurface region 26 and to determine locations and properties of hydrocarbon deposits. To that end, a variety of seismic data processing algorithms may be used to remove noise from the acquired seismic data, migrate the pre-processed seismic data, identify shifts between multiple seismic images, align multiple seismic images, and the like.

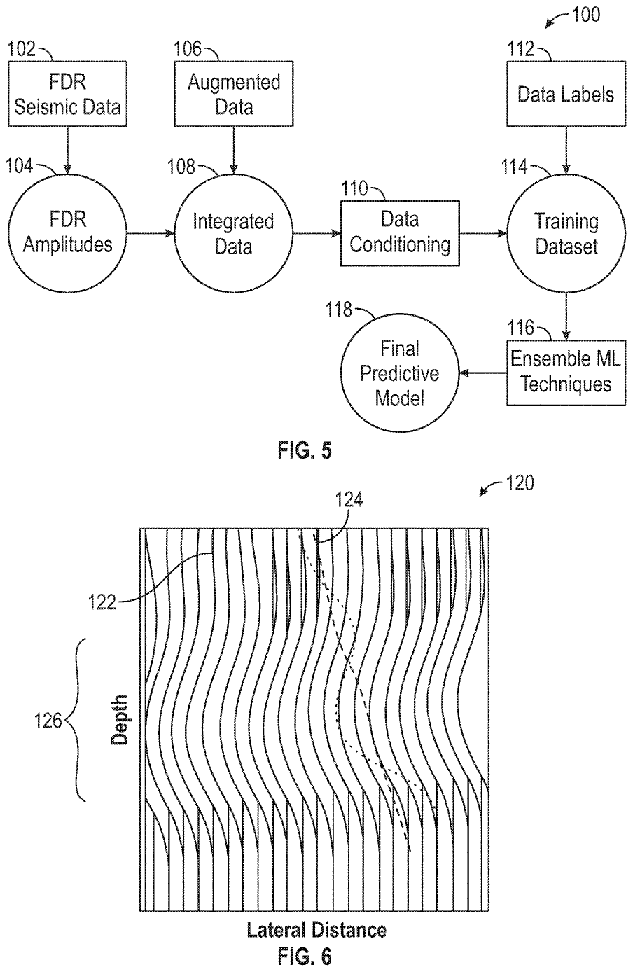

After the computing system 60 analyzes the acquired seismic data, the results of the seismic data analysis (e.g., seismogram, seismic images, map of geological formations, etc.) may be used to perform various operations within the hydrocarbon exploration and production industries. For instance, as described above, the acquired seismic data may be used to perform method 10 of FIG. 1 that details various processes that may be undertaken based on the analysis of the acquired seismic data. Computing system 60 may be utilized to implement other methods described herein, such as methods 100 and 200 shown in FIGS. 5 and 10 and which will be described further herein.

The seismic data obtained from a seismic survey (e.g., conducted via survey systems 22 and 38 shown in FIGS. 1 and 2, respectively) may be used to generate a subsurface model such as a velocity model of the subsurface region from which the seismic data was originally obtained. For instance, an iterative technique referred to as full-waveform inversion (FWI) may be utilized to generate a subsurface model (e.g., a velocity model) of the subsurface region based on seismic data obtained from the subsurface region via the performance of a seismic survey. As used herein, the term “FWI” is defined as including all variants of full-waveform inversion. Certain examples of full-waveform inversion can use pressure and/or multi-component data. Certain examples of full-waveform inversion can use different approximations of physics (such as, for example, acoustic, elastic, visco-elastic, isotropic, and/or anisotropic). FWI can be used for different applications such as applications for estimating 3D velocities, applications for performing multi-parameter inversion, applications for deriving reflectivity volumes, applications for determining 4D difference volumes, applications for determining reflectivity gathers, and/or applications for determining probabilistic inversions, to name a few examples. Generally, FWI includes iteratively minimizes the difference between observed and simulated seismic data to refines the velocity model using the complete amplitude and phase information contained in the wavefield.

Additionally, imaging of the subsurface region may be obtained directly from the subsurface model generated via the performance of FWI through FWI-derived reflectivity (FDR) imaging techniques. Particularly, rather than simply imaging reflectors through a migration condition, FDR imaging extracts reflectivity as part of a model-based inversion process that accounts for the full physics of wave propagation. This integrated approach enables the extraction of quantitative subsurface properties with higher resolution and fidelity. By fully exploiting the wavefield data, FDR imaging may provide enhanced resolution and more accurate amplitude recovery, leading to a more detailed and reliable depiction of subsurface reflectivity in at least some applications. Additionally, the model-based inversion framework of FDR imaging naturally incorporates complex wave phenomena such as multiple scattering and mode conversions, which are often inadequately handled by traditional migration techniques. Additionally, the iterative nature of FWI helps mitigate artifacts and acquisition footprint effects that can plague migration images, ultimately resulting in a more robust and quantitatively accurate subsurface model.

Generally, reflectivity represents the contrasts in subsurface properties, such as acoustic impedance, that cause seismic waves to reflect when travelling through the subsurface region. In FDR, reflectivity in the form of an FDR image having an FDR amplitude for a selected interval of the subsurface region, such as a target reservoir or area of interest (AOI), may be obtained by taking the derivative of the FWI-derived velocity model (e.g., via applying an inversion operator to the velocity model) over the selected interval of the subsurface region. As used herein, the term “interval” refers to a predefined section of vertical depth within a selected subsurface region.

In addition, FDR amplitude of an FDR image may correlate with reservoir properties of interest such as, for example, the presence of one or more selected fluids within the subsurface region including, for instance, hydrocarbons. Conventionally, FDR amplitude may be roughly calibrated using well log data obtained from one or more wells that penetrate the subsurface region. Particularly, well logs comprise measurements obtained via specialized wellbore tools that transit the wellbore to take direct measurements of selected reservoir properties including, for example, porosity, density, sonic, and/or saturation of the reservoir properties. Available well log data may be used to help explain anomalies in the FDR amplitude to predict the presence of selected fluids in the subsurface region.

However, the physics underlying FDR amplitude data is complex and no standard or universal correlations are known between FDR amplitude and the presence of one or more selected fluids in the subsurface region. Factors that influence FDR amplitude include, among others, density leakage, rock-type, depth of diving waves, and reservoir or geologic settings. For instance, if a AOI (e.g., a suspected reservoir) within a subsurface region is deeper than the depth of diving waves of the obtained seismic data, then variations in FDR amplitude are likely due to density leakage. However, if the depth of the diving waves of the obtained seismic data are shallower than the AOI, then variations in FDR amplitude are instead likely due to seismic velocity. In summary, while FDR amplitude may be integrated with other data such as existing well log data, conventional approaches for integrating such data are not comprehensive, qualitative, and subjective in nature such that the resulting predictions of reservoir properties are dependent on the given user's experience and personal biases. Thus, no existing standard methodologies exist for integrating FDR amplitude with additional data such as well log data (e.g., velocity, density) to predict reservoir properties of the subsurface region. As used herein, the term “reservoir properties” is defined as the intrinsic physical and petrophysical attributes of subsurface rock of a subsurface region that determine the capacity of the subsurface rock for storing and transmitting fluids such as water and hydrocarbons in the form of oil and gas. Thus, reservoir properties include fluid saturation (e.g., the presence of different fluids within the pore space of the subsurface rock) and lithology (e.g., rock type and mineral composition).

Accordingly, embodiments of systems and methods for predicting reservoir properties of subsurface regions using FDR are described herein. Particularly, embodiments disclosed herein integrate FDR amplitude with augmented datasets to predict reservoir properties of subsurface regions in a standardized, quantitative manner that eliminates the subjective bias of conventional techniques. In an embodiment, FDR amplitude is augmented with various augmented data that is different from the FDR amplitude and may include, for example, seismic surveying or processing parameters, well log data, rock-properties, and geologic information. Augmented data integrated with FDR amplitude may include, among others, FWI Frequency, data offset, data vintage, shear wave velocity category (e.g., clean sand shaley sand), porosity, change of compressional velocity between overlying shale and the reservoir, change of density between overlying shale and the reservoir, the ratio of compressional velocity to shear wave velocity, the ratio of compressional velocity to density, resistivity, formation depth, reservoir thickness, formation age, the presence of subsalt and extra salt, and seismic acquisition type. All of this data may be labeled with the existing hydrocarbon, brine, or reservoir rock type at that location from an existing well log.

In an embodiment, machine learning (ML) is leveraged to generate a complex, non-linear trained predictive model that models input variables in the form of FDR amplitude and augmented data with output labels in the form of predicted reservoir properties. As an example, for a new AOI or interval, the FDR amplitude for the AOI is extracted and then augmented with augmented data similar in type to the augmented data used to generate the trained predictive model. Given that the interval is new, at least some of the augmented data may be unknown and instead augmented data of other AOIs or intervals of the subsurface region (and/or analogous subsurface regions) may be used that were obtained from pre-exiting well logs. After integrating the FDR amplitude with the augmented data, the trained predictive model is used to predict the reservoir properties of the selected AOI. In some embodiments, after a prediction form one augmented dataset has been obtained, another or second augmented dataset is sampled from the existing distribution. A new prediction is then obtained for the selected AOI using the second augmented dataset. This process may be repeated hundreds or thousands of times using different augmented datasets associated with different AOIs or intervals of the subsurface region (and/or analogous subsurface regions) to generate an ensemble of prediction of the reservoir properties for the selected AOI.

In an embodiment, the trained predictive model produces an ensemble of reservoir property predictions for the selected AOI. The ensemble of reservoir property predictions may provide a distribution of predictions for selected reservoir properties (e.g., the presence of different fluid types in the selected AOI) to provide the user with a measure variance or uncertainty in the ensemble prediction versus a single prediction that does not provide similar contextualizing information. In some embodiments, the ensemble reservoir property prediction may be produced by randomly sampling from estimated distributions of selected augmented data associated with the subsurface region containing the selected AOI.

Referring to FIG. 5, an exemplary method 100 is shown for providing a trained, final predictive model 118 configured to predict reservoir properties (e.g., the presence or absence of one or more selected fluids such as hydrocarbons) of a selected AOI within a subsurface region by integrating FDR seismic data with augmented data. In this exemplary embodiment, method 100 includes extracting selected FDR amplitudes 104 from received FDR seismic data 102. The FDR seismic data 102 may be obtained from a subsurface model of the subsurface region such as a velocity model and the like.

For example, a set of FDR amplitudes 104 may be extracted from FDR seismic data 102 at specific intervals within a reservoir of a subsurface region. In some embodiments, each interval may span one waveform cycle or the distance of a single wavelength along the reservoir. Different numerical methods may be employed for extracting the FDR amplitude 104 for each separate interval along the reservoir including, for example, taking the average, the minimum/maximum, or the root mean square (RMS). In certain embodiments, FDR gathers may be used in lieu of or in addition to the FDR amplitudes 104. In some embodiments, spectral decomposition may be applied to the FDR seismic data 102 to segregate the FDR seismic data 102 into its different frequency components when extracting the FDR amplitudes 104. Referring briefly to FIG. 6, exemplary FDR seismic data 102 corresponds to a reservoir of a subsurface region and includes a plurality of seismic waveforms 122 (only one of which is labeled in FIG. 6 for clarity). Additionally, an existing a wellbore 124 (e.g., from which well log data may be obtained) is shown superimposed over the FDR seismic data 102. Additionally, a selected interval 126 is shown extending in vertical depth and having a magnitude equal to approximately one waveform cycle. In other embodiments, the magnitude of interval 126 may be greater or less than one waveform cycle of the FDR seismic data 120, and the FDR seismic data 120 is only shown by way of example and is not intended to limit the scope of the present disclosure.

Referring again to FIG. 5, method 100 includes applying, in addition to the extracted FDR amplitudes 104, augmented data 106 which is integrated with the FDR amplitudes 104 to provide integrated data 108 associated with a selected subsurface region. Particularly, the FDR amplitude 104 for a selected interval of the subsurface region is integrated with augmented data 106 also corresponding to the same interval of the subsurface region but comprising data other than the FDR amplitude of the selected interval. For example, augmented data 106 may include seismic processing data, rock property data, and/or other types of data of the selected interval.

As used herein, the term “seismic processing data” is defined as data descriptive of how the FDR seismic data 102 was originally acquired from the subsurface region particularly with respect to the interval of interest. Thus, seismic processing data includes, among other parameters, frequency information (e.g., FWI frequency), offset information (e.g., offset acquisition distance), and acquisition type or design (e.g., ocean bottom node (OBN) survey, narrow-azimuth towed streamer (NATS) survey, wide-azimuth towed streamer (WATS) survey). Additionally, as used herein, the term “rock properties” is defined as properties descriptive of the rock or porous medium forming the subsurface region and includes both well log data (e.g., shear wave velocity (Vsh), porosity, the change in compression velocity between overburden shale and sand (ΔVp), the change in bulk density between overburden shale and sand (ΔRho), the ratio of compressional to shear velocity (Vp/Vs correlation), the ratio between compression velocity to bulk density (e.g., Vp/Rho correlation), and resistivity) and geologic data such as formation depth, age of the rock, and salt information such as salt content, extra salt content, and the ratio thereof.

Once integrated data 108 is obtained, the integrated data 108 may be pre-processed or conditioned at data conditioning block 110 of method 100 prior to creating a training dataset 114. Particularly, one or more numerical operations may be performed on the integrated data 108 to bring the different types of information contained in integrated data 108 into conformance with each other. For instance, integrated data 108 may include both unscaled, numerical or continuous variables (e.g., FDR amplitude 104, FWI frequency, offset distance) and textual, or categorical variables (e.g., rock type, seismic acquisition design) that are harmonized prior to forming the training dataset 114.

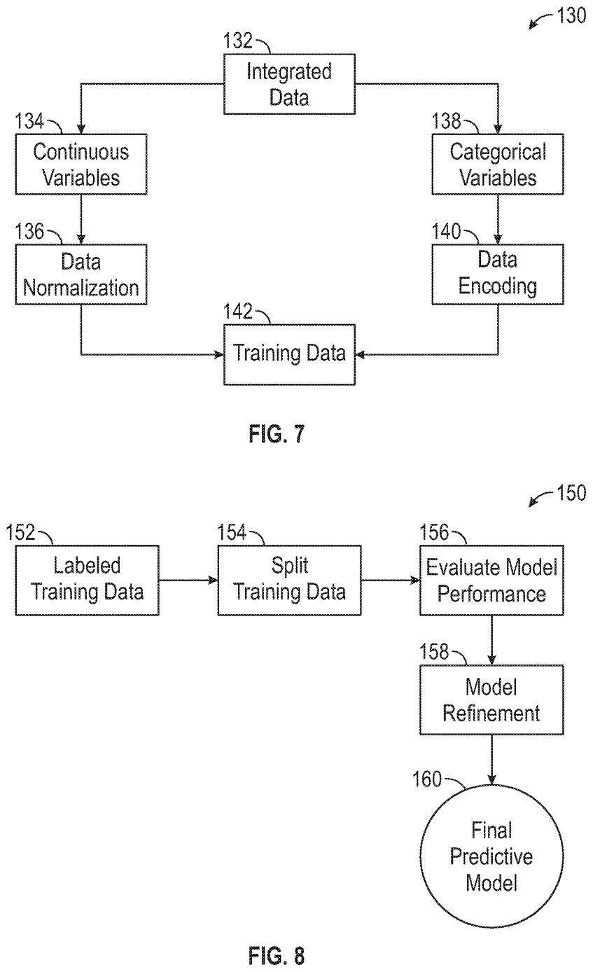

As an example, and referring to FIG. 7, an exemplary method 130 for conditioning integrated data 132 is shown. Integrated data 132 may be similar to the integrated data 108 shown in FIG. 5 and includes both continuous variables 134 and categorical variables 138. In this exemplary embodiment, the continuous variables 134 contained in integrated data 132 are segregated from the categorical variables 138 also contained in integrated data 132. Data normalization 136 is applied to the continuous variables 134 while, in parallel, data encoding 140 is applied to categorical variables 138 whereby the normalized continuous variables 134 are added to the encoded categorical variables 138 to provide pre-processed or conditioned training data 142.

In some embodiments, data normalization 136 of the continuous variables 134 includes applying a normalization function to the continuous variables 134 whereby, for example, the mean may be removed and the continuous variables 134 may be scaled to unit variance. In some embodiments, the normalization function may comprise, for instance, a StandardScaler normalization function. In certain embodiments, data encoding 140 of the categorical variables 138 includes applying an encoding function to the categorical variables whereby, for example, the categorical variables 138 are encoded as a numeric array such as a so-called “one-hot” numeric array comprising binary vectors. In certain embodiments, the encoding function comprises the OneHotEncoder function. As an example of such data conditioning, Table 1 below includes exemplary integrated data 132 for exemplary intervals 0-4 of a reservoir of a subsurface region. In this example, the integrated data 132 presented in Table 1 includes both exemplary continuous variables 134 in the form of FDR amplitude, FWI frequency, and resistivity, and exemplary categorical variables 138 in the form of rock age, salt, and seismic acquisition type.

TABLE 1

| | FDR | FWI | Resist- | | Rock | | Acquisition |
|---|---|---|---|---|---|---|---|
| | Amplitude | Frequency | ivity | Depth | Age | Salt | Type |
| 0 | −2.5 | 11 | 50.0 | 11900 | Miocene | Extra- | WATS |
| | | | | | | Slat | |
| 1 | 1.5 | 11 | 0.2 | 11100 | Miocene | Salt | OBN |
| 2 | −1.5 | 15 | 50.0 | 11900 | Miocene | Extra- | WATS |
| | | | | | | Slat | |
| 3 | −2.7 | 15 | 50.0 | 11700 | Miocene | Extra- | WATS |
| | | | | | | Slat | |
| 4 | −2.0 | 22 | 0.2 | 11100 | Miocene | Salt | OBN |

In addition, Table 2 below illustrates the integrated data 132 of Table 1 of exemplary intervals 0-4 following conditioning whereby the continuous variables 134 of Table 1 have been normalized and the categorical variables 138 of Table 1 have been numerically encoded. Thus, in this example, the continuous variables 134 of Table 1 have had their respective means removed and have been scaled to their unit variance. Additionally, in this example, the categorical variables 138 have been encoded as one-hot numeric arrays.

TABLE 2

| | | | | | Rock | Salt_ | | Acquisition | Acquisition |
|---|---|---|---|---|---|---|---|---|---|
| | FDR | FWI | | | Age_ | Extra- | Salt_ | Type_ | Type_ |
| | Amplitude | Frequency | Resistivity | Depth | Miocene | Slat | Salt | OBN | WATS |
| 0 | −0.693774 | −0.94285 | 0.816497 | 0.981981 | 1.0 | 1.0 | 0.0 | 0.0 | 1.0 |
| 1 | 1.924242 | −0.94285 | −1.224745 | −1.200198 | 1.0 | 0.0 | 1.0 | 1.0 | 0.0 |
| 2 | −0.039270 | 0.049752 | 0.816497 | 0.981981 | 1.0 | 1.0 | 0.0 | 0.0 | 1.0 |
| 3 | −0.824675 | 0.049752 | 0.816497 | 0.436436 | 1.0 | 1.0 | 0.0 | 0.0 | 1.0 |
| 4 | −0.366522 | 1.791067 | −1.224745 | −1.200198 | 1.0 | 0.0 | 1.0 | 1.0 | 0.0 |

Returning to FIG. 5, in other embodiments, the manner in which integrated data 108 is conditioned at data conditioning block 110 may vary from the method 130 shown in FIG. 7. In still other embodiments, method 100 may not include data conditioning block 110 and, instead, the integrated data 108 may be directly converted into the training dataset 114 without an intervening data conditioning block 110.

As described above, in this exemplary embodiment, following conditioning of the integrated data 108 at data conditioning block 110, the training dataset 114 is created from the conditioned integrated data 108. Particularly, training dataset 114 is generated by integrating the conditioned integrated data 108 with data labels 112 which correspond to the dependent variables to be predicted by the final predictive model 118. Thus, data labels 112 correspond to the reservoir properties that the final predictive model 118 will be trained to predict using integrated data (e.g., similar to that of integrated data 108) once it has been trained using the training dataset 114. In some embodiments, data labels 112 include different fluid types (e.g., brine, gas, oil, paleo residual gas (PRG)) present within a given interval of the conditioned integrated data 108. In certain embodiments, data labels 112 include other parameters such as reservoir quality, reservoir saturation, and the like for each interval of the conditioned integrated data 108. Additional examples of data labels 112 include the set of lithofacies type (e.g., gas sand, oil sand, gas silt, oil silt, brine silt, brine sand, and non-reservoir rock or shale), reservoir quality (e.g., good porous sand rock, tight/low porous sand rock, shaley sand, and silt) based on well logs such as Vsh and porosity logs, reservoir saturation including well saturation (where high well saturation is indicative of a lack of recoverable hydrocarbons) (e.g., low saturation, medium saturation, and high saturation). In some embodiments, not all of the data labels 112 may be predicted using integrated data depending on the particular application.

As an example, Table 3 below illustrates an exemplary training dataset 114 formed from the integrated data 108 shown in Table 1 but also including data labels 112 for each interval 0-4 in the form of fluid types oil and brine.

TABLE 3

| | FDR | FWVI | | | Rock | | Acquisition | |
|---|---|---|---|---|---|---|---|---|
| | Amplitude | Frequency | Resistivity | Depth | Age | Salt | Type | Label |
| 0 | −2.5 | 11 | 50.0 | 11900 | Miocene | Extra-Slat | WATS | Oil |
| 1 | 1.5 | 11 | 0.2 | 11100 | Miocene | Salt | OBN | Brine |
| 2 | −1.5 | 15 | 50.0 | 11900 | Miocene | Extra-Slat | WATS | Oil |
| 3 | −2.7 | 15 | 50.0 | 11700 | Miocene | Extra-Slat | WATS | Oil |
| 4 | −2.0 | 22 | 0.2 | 11100 | Miocene | Salt | OBN | Brine |

Having created the training dataset 114, method 100 proceeds in this exemplary embodiment at block 116 where an ensemble ML technique is employed using the training dataset 114 to create the final predictive model 118 for predicting reservoir properties using integrated data 108. In some embodiments, the final predictive model 118 comprises a complex, non-linear, and trained predictive model for predicting reservoir properties for different intervals of a subsurface region based on the integrated data 108 inputted to the final predictive model 118 for those selected intervals.

As an example, and referring to FIG. 8, an exemplary method 150 for producing a trained, final predictive model 160 (e.g., similar to the final predictive model 118 shown in FIG. 5) from labeled training data 152 (e.g., similar to training dataset 114 shown in FIG. 5) is shown. In this exemplary embodiment, method 150 includes at block 154 splitting the labeled training data 152 into a training dataset and a corresponding validation dataset. The split training dataset may be used to train the ML predictive models while the split validation dataset may be used to validate or test their performance.

In this exemplary embodiment, an ensemble ML technique is employed to generate the final predictive model 160. In other words, the split training dataset is applied to a plurality or ensemble of different ML predictive models to separately train each different ML predictive model while the split validation dataset is applied to the ensemble of trained ML predictive models to evaluate the performance of each in correctly predicting the labels of the valuation dataset. In this manner, the predictions of several different base, ML predictive models may be aggregated to enhance the generalizability and mitigate overfitting of the resulting final predictive model 160. This technique may be particularly useful in predicting reservoir properties given the generally limited amount of training data (e.g., due to scarce well log data and the like) that may be accessible in at least some applications. Such ensemble ML techniques include random forests where predictions are aggregated from multiple decision trees, gradient boosting where different weak learners are combined sequentially to create a strong leaner by focusing on mistakes of previous models, among others.

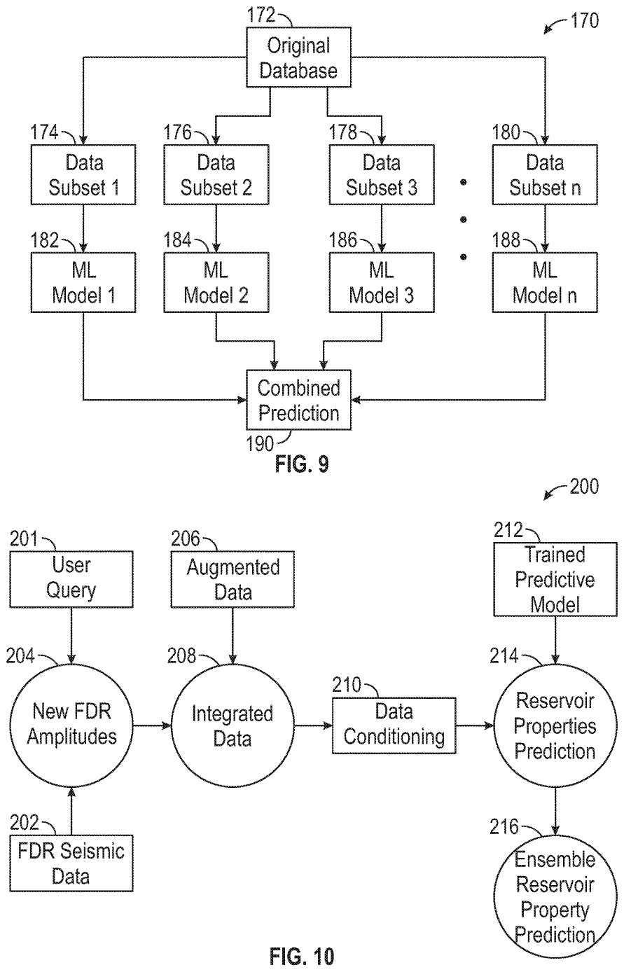

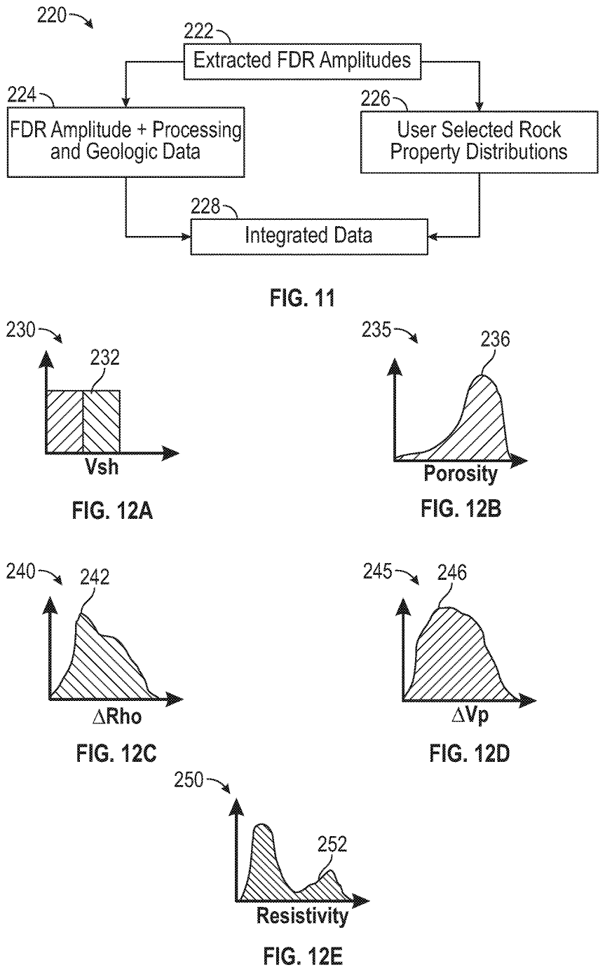

Referring briefly to FIG. 9, an exemplary ML ensemble technique 170 is shown that can, in some embodiments, be implemented by method 150 shown in FIG. 8. In this example, an original dataset 172 comprising integrated data such as either the split training dataset or the validation dataset produced at block 154 of method 150 shown in FIG. 8. The original dataset 172 is divided evenly into a plurality of data subsets including a first data subset 174, a second data subset 176, a third data subset 178, and an nth data subset 180 representing the fact that the magnitude of different data subsets into which the original dataset 172 is divided may vary substantially depending on the requirements of the given application.

In this example, ML ensemble technique 170 additionally includes a plurality of ML models 182, 184, 186, and 188 which receive the divided data subsets 174, 176, 178, and 180. Particularly, the first data subset 174 is applied to the first ML model 182 which outputs a unique first prediction (e.g., reservoir properties such as fluid type), the second data subset 176 is applied to the second ML model 184 which outputs a unique second prediction, the third data subset 178 is applied to the third ML model 186 which outputs a unique third prediction, and the nth data subset 180 is applied to the nth ML model 188 which outputs a unique nth prediction. The ML models 182, 184, 186, and 188 may comprise varying types of ML models such as random forest models, gradient boosted models, and the like. Ultimately, each of the predictions outputted by ML models 182, 184, 186, and 188 is aggregated as a combined prediction 190 (e.g., of reservoir properties such as fluid type) of the ensemble ML technique 170. The combined prediction 190 may be a mean, mode, weighted average, stacking, blending, or other combination of the predictions of the different ML models 182, 184, 186, and 188.

Returning briefly to FIG. 8, in this exemplary embodiment, method 150 continues at block 156 where the performance of the trained predictive model developed at block 154 is evaluated. The performance of the trained predictive model may be evaluated in accordance with a variety of different metrics including, among others, accuracy, precision, recall, and a confusion matrix. In some embodiments, block 156 comprises evaluating in parallel the performance of a plurality of different trained predictive models developed at block 154. Particularly, different predictive models may generate different predictions, and thus evaluating a plurality of different predictive models in parallel incorporates this epistemic uncertainty into consideration. Leveraging a plurality of different predictive models may capture a wider range of possible model configurations to reduce the uncertainty produced from a lack of model knowledge. For instance, in some embodiments, a combined prediction may be obtained by method 150 that is produced by a plurality of different trained predictive models. Additionally, in certain embodiments, at least some of the trained predictive models evaluated at block 156 comprise ensemble models developed at block 154. Leveraging ensemble models may

In this exemplary embodiment, method 150 includes at block 158 refining the trained predictive model evaluated at block 156 in order to produce the final predictive model 160. Particularly, the trained predictive model may be refined at block 158 by determining the contribution of each input (e.g., each type of data contained in labeled training data 152) to the prediction outputted by the trained predictive model in order to maximize the performance of the trained predictive model. In some embodiments, a technique referred to as Shapley Additive explanations (SHAP) is used to refine the trained predictive model at block 158. Generally, SHAP computes Shapley values from coalitional game theory to determine the contribution of each feature to a prediction made by the trained predictive model. Alternatively, techniques other than SHAP may be utilized at block 158 to refine the trained predictive model to produce the final predictive model 160. With the contributions of each type of input data contained in labeled training data 152 determined, the different weights applied to each may be adjusted or refined in view of that determination. Leveraging SHAP may optimize the determination of which features are important and which are not important. Particularly, in implementing SHAP, features that do not increase confidence of the prediction or do not add any additional information are removed. For different models different features may have different weights or contributions to the final prediction. Thus, the removal of features will be case dependent. In still other embodiments, method 150 may not include block 158 and instead the final prediction model 160 may be produced at block 156 thereof.

Referring to FIG. 10, an exemplary method 200 is shown for providing an ensemble reservoir property prediction 216 in response to receiving a user query 201. Particularly, the user query 201 may request a prediction regarding the reservoir properties of an AOI of a selected subsurface region encompassing one or more intervals contained within the subsurface region. At block 204, FDR amplitudes for the intervals of the subsurface region encompassed by the AOI contained in the user query 201 are obtained from FDR seismic data 202. In some embodiments, in lieu of or in addition to the FDR amplitudes of the intervals corresponding to the AOI contained in the user query 201, FDR gathers and spectral data (e.g., obtained via spectral decomposition) may also be extracted from FDR seismic data 202 for those same intervals.

Once the relevant FDR amplitudes are extracted at block 204, integrated data 208 is obtained by aggregating augmented data 206 also associated with the subsurface region of the AOI captured in the user query 201. Such augmented data 206 may include seismic processing data associated with the FDR seismic data 202 for the given intervals encompassed by the AOI and/or rock properties of the subsurface region. As an example, and referring to FIG. 11, an exemplary method 220 is shown for obtaining integrated data 228 that includes extracted FDR amplitudes 222. In this exemplary embodiment, at block 224, the extracted FDR amplitudes obtained at block 222 are aggregated with seismic processing data associated with the intervals encompassed by the AOI as well as geologic data of the subsurface region containing the AOI such as, for example, formation depth, age of the subsurface region, and salt information. The seismic processing data and geologic data for the intervals encompassed by the AOI may be known by the user based on records of the seismic survey that was originally conducted when obtaining the FDR seismic data and the geologic data may be known from previous research conducted regarding the subsurface region.

At block 226, the user selects rock property distributions to aggregate with the FDR amplitudes, seismic processing, and geologic data obtained at block 224 to obtain integrated data 228. Such rock properties may generally be obtained via well logs and the actual rock properties for the specific intervals encompassed by the AOI contained in the user query may be unknown. However, the rock properties of these selected intervals are estimated at block 226 by randomly sampling rock property distributions of the subsurface region containing the AOI and the selected intervals. Particularly, distributions of different rock properties (e.g., porosity, bulk density, compressional velocity, resistivity) may be known based on well log data obtained from previously drilled wells in the subsurface region that do not however extend through the AOI captured in the user query. Therefore, by sampling such distributions, estimates for the missing rock properties of the intervals encompassed in the AOI may be obtained and aggregated with the FDR amplitudes, processing, and geologic data obtained from block 224 to obtain the integrated data 228.

Referring briefly to FIS. 12A-12E, exemplary rock property distributions 230, 235, 240, 245, and 250 are shown. Rock property distributions 230, 235, 240, 245, and 250 indicate a selected rock property along the X-axis thereof and a likelihood of occurrence of the selected rock property in a given subsurface region. Rock property distributions 230, 235, 240, 245, and 250 may provide estimated distributions for rock properties in a selected subsurface region (e.g., containing an AOI captured in a user query) based on cumulative knowledge of such rock properties of the subsurface region obtained from, for example, different well logs captured from preexisting wells penetrating the subsurface region. Particularly, rock property distribution 230 illustrates an estimated shear velocity (Vsh) distribution 232 of the subsurface region; rock property distribution 235 illustrates an estimated porosity distribution 236 of the subsurface region; rock property distribution 240 illustrates an estimated change in bulk density (ΔRho) distribution 242 of the subsurface region; rock property distribution 245 illustrates an estimated change in compressional velocity (ΔVp) distribution 246 of the subsurface region; and rock property distribution 250 illustrates an estimated resistivity distribution 252 of the subsurface region. Rock property distributions 230, 235, 240, 245, and 250 are only exemplary, and the rock property distributions obtained at block 226 of method 220 shown in FIG. 11 may vary from the rock property distributions 230, 235, 240, 245, and 250.

Returning to FIG. 10, the method 220 shown in FIG. 11 is only exemplary and the integrated data 208 obtained in method 200 may vary from the methodology illustrated in FIG. 11. At block 210 of method 200, the integrated data 208 is pre-processed or conditioned prior to being applied to a trained predictive model 212 to produce a reservoir properties prediction 214. In some embodiments, the data conditioning performed at block 210 is similar to the data conditioning performed at block 110 of method 100 shown in FIG. 5 and thus, for example, may employ the methodology shown in FIG. 7. In other embodiments, the data conditioning performed at block 210 may vary from that is performed at block 110 of the method 100 shown in FIG. 5. Additionally, the trained predictive model 212 employed in method 200 may, in some embodiments, comprise the final predictive model 118 obtained by method 100 shown in FIG. 5.

The reservoir properties prediction 214 comprises a single prediction of one or more reservoir properties of the AOI captured in user query 201. For instance, the reservoir properties prediction may predict the fluid types present in the selected AOI. Additionally, in this exemplary embodiment, a plurality of reservoir properties predictions 214 are obtained to form an ensemble reservoir property prediction 216. Particularly, as described above, the rock properties included in integrated data 208 may be randomly sampled from different rock property distributions associated with the subsurface region generally rather than the AOI specifically. The ensemble reservoir property prediction 216 may be obtained by producing a plurality or ensemble of integrated data 208 and producing a reservoir property prediction 214 for each different set of integrated data 208 of the ensemble of integrated data 208. In some embodiments, for each set of different integrated data 208 the different rock property distributions may be randomly sampled to produce different sets of estimated rock properties for the selected AOI thus making each set of integrated data 208 unique among the ensemble. For instance, thousands of sets of integrated data 208 may be obtained by randomly sampling the rock property distributions of the subsurface region a corresponding number of times. In this manner, an ensemble reservoir property prediction 216 may be obtained for the selected AOI that includes thousands of unique reservoir property predictions 214. Alternatively, in some embodiments, method 200 may include only making a single reservoir properties prediction 214 rather than the ensemble reservoir property prediction 216.

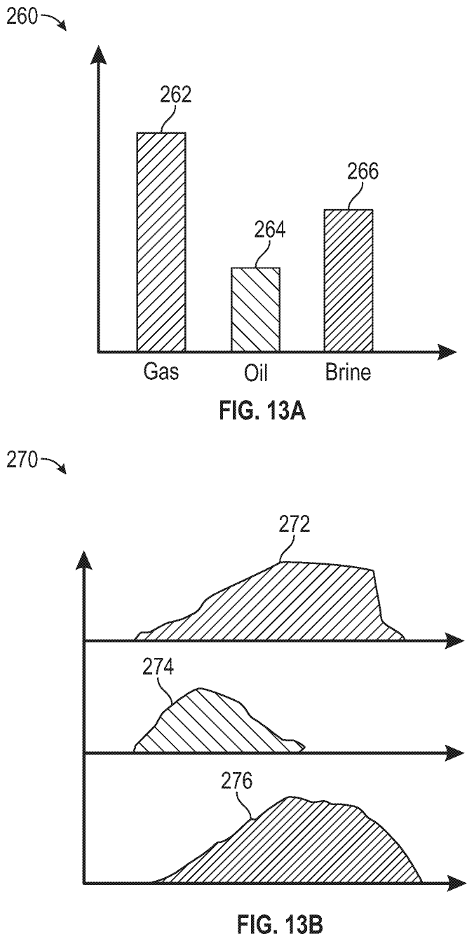

As an example, and referring to FIGS. 13A and 13B, different visualizations 260 and 270 of exemplary ensemble reservoir property predictions are shown for a selected AOI (e.g., captured in a user query). Particularly, FIG. 13A shows a histogram 260 illustrating along the Y-axis thereof the relative probability of occurrence of gas sand 262, the presence of oil sand 264, and the presence of brine sand 266 in the selected AOI. As shown in FIG. 13A, histogram 260 illustrates that greatest relative probability of occurrence is the presence of gas sand 262, followed by the presence of brine sand 266, and followed finally by the presence of oil sand 264. Additionally, FIG. 13B illustrates a graph 270 depicting probability distributions of the presence of gas sand 272, the presence of oil sand 274, and the presence of brine sand 276 for the same selected AOI. Particularly, the Y-axis of graph 270 depicts the probability of occurrence while the X-axis thereof depicts AOI volume of shale values.

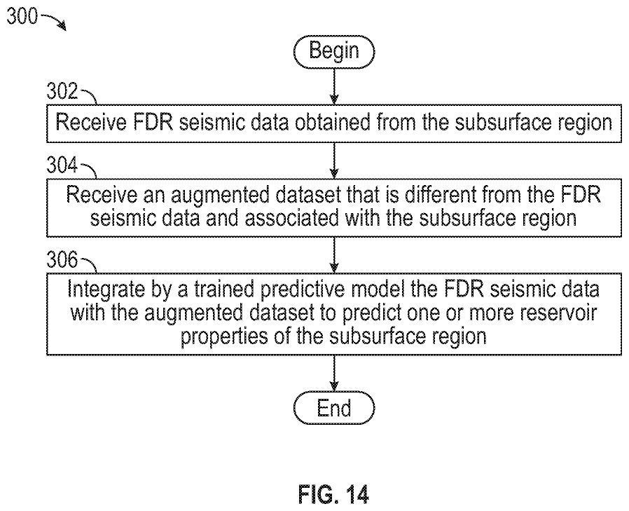

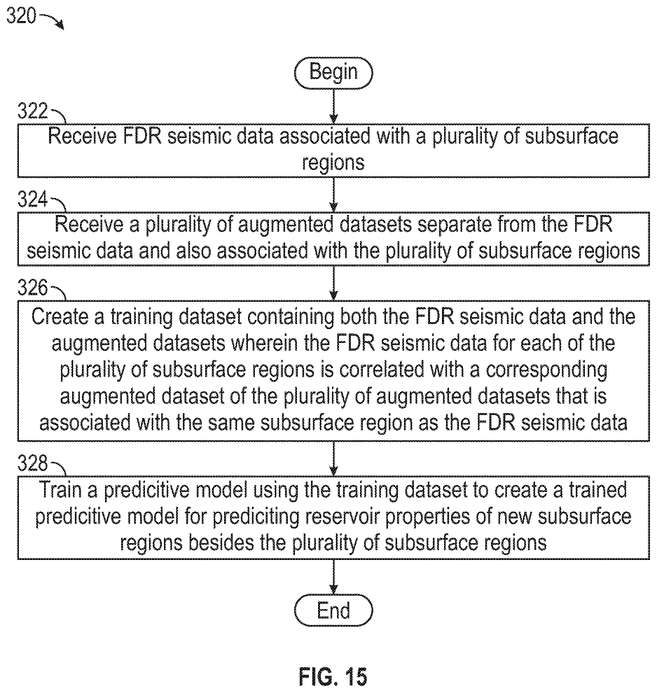

Referring to FIG. 14, an exemplary method 300 is shown for predicting reservoir properties of subsurface regions (e.g., subsurface region 26 shown in FIGS. 2 and 3) using FDR. Initially, at block 302, method 300 includes receiving FDR seismic data (e.g., FDR seismic data 102 of FIG. 6, FDR. seismic data 202 of FIG. 10) obtained from the subsurface region.

At block 304, method 300 includes receiving an augmented dataset (e.g., augmented data 106 of FIG. 5, augmented data 206 of FIG. 10) that is different from the FDR seismic data and associated with the subsurface region. At block 306, method 300 includes integrating by a trained predictive model (e.g., final predictive model 118 of FIG. 5, trained predictive model 212 of FIG. 10) the FDR seismic data with the augmented dataset to predict one or more reservoir properties (e.g., reservoir properties prediction 214 of FIG. 10) of the subsurface region.

Referring to FIG. 14, an exemplary method 320 is shown for creating a trained predictive model for predicting reservoir properties of subsurface regions (e.g., subsurface region 26 shown in FIGS. 2 and 3) using FDR. Initially, at block 322, method 320 includes receiving FDR seismic data (e.g., FDR seismic data 102 of FIG. 6, FDR. seismic data 202 of FIG. 10) associated with a plurality of subsurface regions.

At block 324, method 320 includes receiving a plurality of augmented datasets (e.g., augmented data 106 of FIG. 5, augmented data 206 of FIG. 10) separate from the FDR seismic data and also associated with the plurality of subsurface regions. At block 326, method 320 includes creating a training dataset (e.g., training dataset 114 of FIG. 5) containing both the FDR seismic data and the augmented datasets wherein the FDR seismic data for each of the plurality of subsurface regions is correlated with a corresponding augmented dataset of the plurality of augmented datasets that is associated with the same subsurface region as the FDR seismic data. At block 328, method 320 includes training a predictive model (e.g., ensemble ML techniques of block 116 of FIG. 5) using the training dataset to create a trained predictive model (e.g., final predictive model 118 of FIG. 5, trained predictive model 212 of FIG. 10) for predicting reservoir properties (e.g., reservoir properties prediction 214 of FIG. 10) of new subsurface regions besides the plurality of subsurface regions.

While exemplary embodiments have been shown and described, modifications thereof can be made by one skilled in the art without departing from the scope or teachings herein. The embodiments described herein are exemplary only and are not limiting. Many variations and modifications of the systems, apparatus, and processes described herein are possible and are within the scope of the disclosure. For example, the relative dimensions of various parts, the materials from which the various parts are made, and other parameters can be varied. Accordingly, the scope of protection is not limited to the embodiments described herein, but is only limited by the claims that follow, the scope of which shall include all equivalents of the subject matter of the claims. Unless expressly stated otherwise, the steps in a method claim may be performed in any order. The recitation of identifiers such as (a), (b), (c) or (1), (2), (3) before steps in a method claim are not intended to and do not specify a particular order to the steps, but rather are used to simplify subsequent reference to such steps.

What is claimed is:

1. A computer-implemented method for predicting reservoir properties of subsurface regions using full waveform inversion derived reflectivity (FDR), the method comprising:
(a) receiving FDR seismic data obtained from a subsurface region;
(b) receiving an augmented dataset that is different from the FDR seismic data and associated with the subsurface region; and
(c) integrating by a trained predictive model the FDR seismic data with the augmented dataset to predict one or more reservoir properties of the subsurface region.

2. The method of claim 1, wherein the one or more reservoir properties are of a selected area of interest (AOI) contained in the subsurface region.

3. The method of claim 1, wherein the FDR seismic data comprises a FDR image volume of the subsurface region.

4. The method of claim 1, wherein the augmented dataset comprises at least one of rock properties, processing data, and geologic data associated with the subsurface region.

5. The method of claim 1, wherein the augmented dataset comprises rock properties, processing data, and geologic data associated with the subsurface region.

6. The method of claim 1, further comprising:
(d) extracting FDR amplitudes from the FDR seismic data at predefined intervals within the subsurface region; and
wherein (c) comprises integrating by the trained predictive model the FDR amplitudes with the augmented dataset to predict the one or more reservoir properties of the subsurface region.

7. The method of claim 1, wherein the FDR seismic data comprises FDR amplitudes at predefined intervals within the subsurface region.

8. The method of claim 7, wherein the one or more reservoir properties comprise a presence of hydrocarbons within the subsurface region.

9. The method of claim 7, wherein the FDR amplitudes comprise at least one of an average FDR amplitude, a minimum or maximum FDR amplitude, and a root means square (RMS) FDR amplitude.

10. The method of claim 1, wherein the one or more reservoir properties comprises one or more fluid types present in the subsurface region.

11. A computer-implemented method for creating a trained predictive model for predicting reservoir properties of subsurface regions using full waveform inversion derived reflectivity (FDR), the method comprising:
(a) receiving FDR seismic data associated with a plurality of subsurface regions;
(b) receiving a plurality of augmented datasets separate from the FDR seismic data and also associated with the plurality of subsurface regions;
(c) creating a training dataset containing both the FDR seismic data and the augmented datasets wherein the FDR seismic data for each of the plurality of subsurface regions is correlated with a corresponding augmented dataset of the plurality of augmented datasets that is associated with the same subsurface region as the FDR seismic data; and
(d) training a predictive model using the training dataset to create a trained predictive model for predicting reservoir properties of new subsurface regions besides the plurality of subsurface regions.

12. The method of claim 11, wherein the FDR seismic data comprises FDR amplitudes at predefined intervals within a subsurface region of the plurality of subsurface regions associated with the FDR seismic data.

13. The method of claim 12, wherein the one or more reservoir properties comprise the presence of hydrocarbons within the subsurface region.

14. The method of claim 11, wherein the one or more reservoir properties comprises one or more fluid types present in the subsurface region.

15. The method of claim 11, wherein (d) comprises training the predictive model to create the trained predictive model for predicting an ensemble of reservoir properties of the new subsurface regions.

16. A system comprising:
a one or more processors; and
a storage device coupled to the one or more processors, the storage device configured to store instructions that, when executed by the one or more processors, configure the one or more processors to:
(a) receive FDR seismic data obtained from a subsurface region;
(b) receive an augmented dataset that is different from the FDR seismic data and associated with the subsurface region; and
(c) integrate by a trained predictive model the FDR seismic data with the augmented dataset to predict one or more reservoir properties of the subsurface region.

17. The system of claim 16, wherein the FDR seismic data comprises FDR amplitudes at predefined intervals within the subsurface region.

18. The system of claim 17, wherein the one or more reservoir properties comprises the presence of hydrocarbons in the subsurface region.

19. The system of claim 16, wherein the one or more reservoir properties comprises one or more fluid types present in the subsurface region.

20. The system of claim 16, wherein the FDR seismic data comprises a FDR image volume of the subsurface region.
